(19) United States
(12) Patent Application Publication
(10) Pub. No.: US 2011/0204840 A1
(43) Pub. Date: Aug. 25, 2011

(54) METHOD OF ACTUATING A SINGLE-PHASE MOTOR, A SYSTEM FOR ACTUATING A SINGLE-PHASE MOTOR AND A SINGLE PHASE MOTOR

(76) Inventors: Lucas Mondardo Cúnico, Joinville (BR); Douglas Pereira da Silva, Joinville SC (BR)

(21) Appl. No.: 12/673,557

(22) PCT Filed: Aug. 15, 2008
(86) PCT No.: PCT/BR08/00243

§ 371 Date: Feb. 15, 2010

(30) Foreign Application Priority Data
Aug. 15, 2007 (BR) PI0703400-

(51) Int. Cl. H02P 1/44

(52) U.S. Cl. 318/795

(57) ABSTRACT

The present invention relates to a method of actuating a single-phase motor, a system for actuating a single-phase motor and a single-phase motor, especially applied to a system that enables one to actuate single-phase induction motors of the CSR (capacitive start and run) type, as well as single-phase induction motors of the RSIR (resistive start inductive run), RSCR (resistive start capacitive run) and CSIR (capacitive start inductive run) types. The proposed method enables the system to actuate indistinctly any of the configurations of single-phase induction motor (6) with an auxiliary start winding (S), through a command logic responsible for connecting the start winding (S) in parallel with the main winding (R), keeping both disconnected from the network voltage (V_{AC}) and keeping them in this way for a first start time (tₐ), after the first start time (ta), simultaneously keeping the start winding (S) and the main winding (R) connected to the network voltage (V_{AC}) for a second time (t_{b}), and after the second start time (tb) has passed, disconnecting the start winding (S) from the network voltage (V_{AC}).

This application claims priority of Brazilian patent case No. PI0703400-8 filed on Aug. 15, 2007, the disclosure thereof being hereby incorporated by reference.

The present invention relates to a method of actuating a single-phase motor, a system for actuating a single-phase motor and a single-phase motor proper, a control system according to the teachings of the present invention being provided. The teachings of the present invention are particularly advantageous in single-phase induction motors, especially because the method and the system of the present invention enable one not only to actuate the single-phase induction motors of the CSR type (capacitive start and run), as well as of single-phase induction motors of the RSIR type (resistive start inductive run), RSCR (resistive start capacitive run) and CSIR type (capacitive start inductive run).

The invention can be particularly usable in single-phase induction motors, much used in daily life, and the so-called fractional powers are often provided, for example ⅛, ¼, ⅓, ½, 2 HP, etc.). Among the single-phase induction motors with auxiliary winding, there are the four configurations already described (CSR, RSIR, RSCR, CSIR), two of them being for start and two for run, and the system and method proposed herein can be applied to the four configurations.

### DESCRIPTION OF THE PRIOR ART

The techniques of actuating single-phase induction motors at present use potential relays, current relays, PTC (positive temperature coefficient) thermistors and timed devices. At present, single-phase induction motors of the CSIR type and RSIR type use current relays and single-phase induction motors of the RSCR type use PTC thermistors and timed devices.

Potential relays, current relays and PTC thermistors have the disadvantage of presenting electric parameters strongly dependent on the design of the motor on which the element will be applied, generating a high number of SKU's (stock keeping units), which increases the complexity and makes the management of materials expensive.

### BRIEF DESCRIPTION OF THE OBJECTIVES OF THE INVENTION

One of the objectives of the present invention is to provide a method of actuating a single-phase motor, which controls the actuation of a single-phase induction motor capable of meeting with a single system four types of motors, namely: CSR, CSIR, RSIR and RSCR.

The first type of motor mentioned, called CSR, is of particular interest because it is usually a motor with higher capacity than the others and for which, in the present state of the art, one employs actuation devices of higher cost, as for instance, potential relays.

Such devices, said potential relays, require a precise determination of the levels of ON/OFF voltage depending on the motor employed. This determination process requires specialized knowledge of the motor design and takes considerable time, since it is necessary to evaluate the set of different conditions of input voltage and operation temperature. Such a characteristic of potential relays implies the manufacture of a large number of SKU's of these devices, in order to meet the different models of motor in existence.

Another objective of this invention is to provide a robust actuation method, aggregating the benefits that electronics can provide to the application of single-phase induction motors, in particular those applied to compressors used in cooling.

The use of a control unit provides the possibility of minimum timing of the stoppage of these compressors, guaranteeing an advantageous situation for the next start. This advantageous situation, in many cases, enables the start capacitor used in some of the above-cited configurations to be suppressed, resulting in an economical advantage, since in these cases the start circuit will only be formed by a switch in series with the auxiliary winding. The possibility of avoiding the use of a start capacitor, in many situations, as mentioned, is especially employed in cooling, wherein advantageous start conditions take place, that is to say, when the system that equalizes the necessary start torque is lower and, since the start capacitor is an element that is added only to increase the start torque, it may be dispensed with.

The great majority of these compressors for cooling take advantage of the same motors mentioned now, enabling the system proposed herein to be used without restrictions in the actuation of their motors.

In a general way, it is an objective of this invention to provide a system that is capable of actuating single-phase induction motors, employed in any application, which have an auxiliary winding for start and that use any of the configurations mentioned before.

Moreover, the system also admits the use of a control unit, responsible for the generation of the actuation commands of the switches. This unit enables the inclusion of protection algorithms, for both the motor and the compressor or another element of which the motor is part. These algorithms may be, for instance, current, voltage and/or temperature protections, among others.

The control method, made feasible by the control unit, can make use of electric information such as current and/or voltage of the electric network and/or voltage of one or more branches that feed the motor, for example, based on the teachings of patent document WO2005/034330, incorporated hereinto by reference and use them for implementing the strategy of actuating the switches.

The convenient form in which the switch command signals are generated by the control method contributes to achieve the objectives of the invention, providing a lower level of stress on the switches.

As already mentioned, an example of this type of situation is the application of these induction motors in actuating hermetic compressors for cooling. This occurs because, after the start of the compressor, the suction and discharge pressures of the cooling system are in conditions that require a high start torque of the motor so that it will be able to start and accelerate until the load point. The control method according to the teachings of the present invention, by timing the start of the compressor, in systems that make use of a capillary tube as an expansion device guarantees the time necessary for said pressures to become equalized, and that in the next start the required torque will be lower with respect to the unequalized condition, thus bringing about economy of the start capacitor.

Such objectives are achieved by means of a method of actuating a single-phase motor, the motor being fed by a network voltage and comprising a main winding and a start winding, both connectable to the network through a run switch, the motor further comprising a start circuit selectively connectable in series with the start winding through a start switch, the start switch comprising contacts, and a run capacitor, the run capacitor being connected in parallel to the start circuit. The motor start comprises steps of connecting the start winding in parallel with the main winding, keeping both unconnected from the network voltage and keeping them in this way for a first start time; after the fist start time, simultaneously maintaining the start winding and the main winding connected to the network voltage for a second start time; and after the second start time is over, disconnecting the start winding from the network voltage; the first start time being configured so that the contacts of the start switch will be engaged.

The objectives of the present invention are further translated by a system for actuating a single-phase motor, the motor being feedable by a network voltage and comprising a main winding and a starting winding, the motor further comprising a start circuit selectively connectable in series with the start winding and a run capacitor, the run capacitor being connected in parallel to the start circuit, the system comprising a control unit configured for connecting the start winding in parallel with the main winding, every time the motor is turned on, keeping both disconnected from the network voltage and keeping them in this way for a first start time, then simultaneously keeping the start winding and the main winding connected to the network voltage for a second start time and disconnecting the start winding from the network voltage.

### BRIEF DESCRIPTION OF THE DRAWINGS

The present invention will now be described in greater detail with reference to embodiments represented in the drawings. The figures show:

FIG. 1 represents a first embodiment of the schematic diagram of the system for actuating a single-phase motor, in which the control method of the present invention can be applied;

FIG. 2 represents a second embodiment of the schematic diagram of the system for actuating the single-phase motor in which the control method of the present invention can be applied, and

FIG. 3 represents a time diagram of the command signals of the switch of a system for actuating a single-phase motor according to the present invention.

### DETAILED DESCRIPTION OF THE DRAWINGS

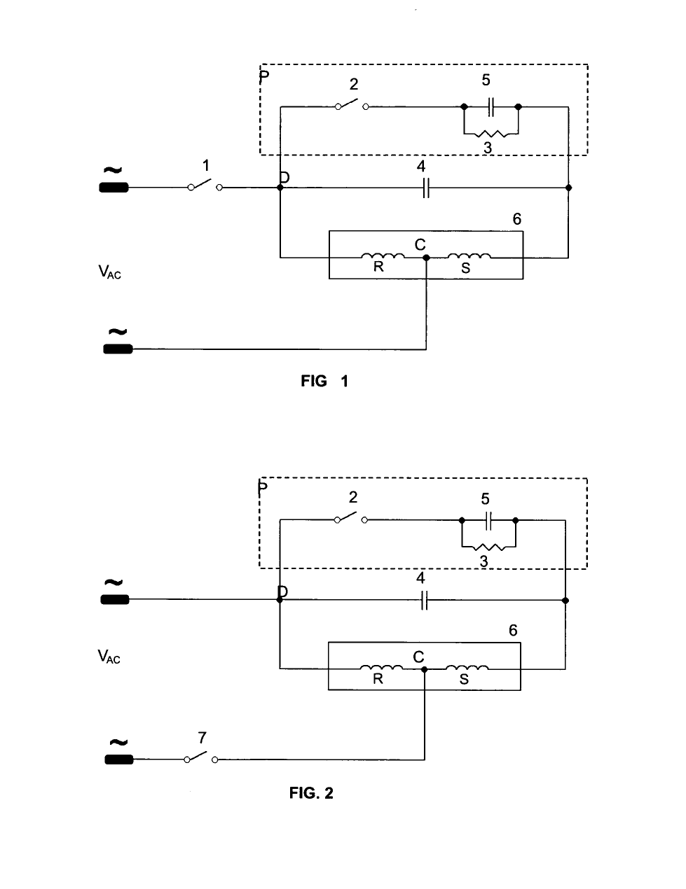

As can be seen in FIGS. 1 and 2, the system for actuating a single-phase motor 6 comprises a start circuit P, a run switch 1,7 and a start switch 2. The motor 6 comprises a main winding R and a start winding S, and is selectively connectable to the network voltage V_{AC} through the run switch 1, 7.

The start circuit P comprises the start switch 2 associated in series with a start capacitor 5, which in turn comprises a discharge resistor 3 connected in parallel, the assembly being connectable in series with the start winding S and, at the same time, connectable in parallel with the run capacitor 4, so that this run capacitor 4 will be connected in parallel with the start circuit P. In determined configurations, the run capacitor 4 will not be present, without, however, affecting the concepts of the present invention.

A control unit (not shown) electrically associated to the start switch 2 and run switch 1, 7 is configured in such a way that, whenever the motor 6 is turned on, the start winding S will be connected in parallel to the main winding R, keeping both of them disconnected from the network voltage V_{AC} and keeping them in this way for a first start time tₐ, and later simultaneously keeping the start winding S and the main winding R connected to the network voltage V_{AC} for a second start time t_{b} and disconnecting the start winding S from the network voltage V_{AC}. This sequence of actuation guarantees that, once the motor 6 has been energized, not only it will be guaranteed that the contacts of the start switch 2 will be engaged, but also that the run capacitor 4 will be discharged, thus preventing a discharge thereof by a circuit having low inertia for the current, which is the case of the circuit formed by the run capacitor 4, the start capacitor 5, if the latter is present, and the start switch 2. Such an effect occurs because the start switch 2 is in parallel with the run capacitor 4 and, being thus configured, the switch 2 can only be actuated if the voltage in the run capacitor 4 is equal to zero at the actuation moment; otherwise there is a discharge of the run capacitor 4 through the start switch 2 through the latter, as already described, a discharge circuit, that is to say, a low-impedance circuit. Additionally, this discharge is destructive for the start switch 2.

Thus, taking into consideration this situation, the control unit should be configured so that the first start time tₐ will have the duration necessary to guarantee that the contacts of the start switch 2 will be engaged.

Although the configuration of the system of the present invention enables the start of the motor without the use of a start capacitor 5, when this component is employed it is necessary to employ a discharge resistor 3, connected in parallel with the start capacitor 5, the start capacitor 5 being discharged by the discharge resistor 3.

As to the operation of the system, it will be addressed in greater detail in the description of the method proposed herein, but one should configure the control unit so that the second start time t_{b} will be sufficiently long for the motor 6 to reach an adequate velocity and, thus, the start circuit P can be turned off from the opening of the start switch 2.

With regard to the switches themselves, they should be bidirectional in current and voltage, the run switch 1,7 being connected to the network voltage V_{AC} and the other connected to the main winding R (see knot C in FIGS. 1 and 2) of the motor 6. In the case of the start switch 2, it should also be bidirectional in current and voltage and have a terminal connected to the main winding R of the motor 6 and the other terminal connected to the start winding S, intercalated or not by the start capacitor 5. In addition, the switches may be both electromechanical and semiconductors, or any association of these two types. However, it is in the case where one employs the former, be it in association with a semiconductor or not, that the method proposed herein has the greatest advantage. Such an advantage is more relevant in electromechanical switches, since with them one does not have control over the interval of time existing between the switch command and the reach engagement of the contacts. In a simultaneous actuation thereof, the rung capacitor is charged with a determined level of voltage and discharged through the auxiliary winding, which may cause destruction of the start switch 2, but this will not occur in the systems and motors that employ the method proposed herein. In spite of the advantage of electromechanical switches, the system and method proposed here are applicable to semiconductor switches.

FIGS. 1 and 2 illustrate two configurations of the system of the present invention, wherein, according to a first embodiment of the present invention (see FIG. 1), the run switch 1 makes selective connection between the network voltage V_{AC} and the main winding R, directly at the knot that makes the connection with the run capacitor 4 and the start circuit P (see knot D). According to a second embodiment (see FIG. 2), the run switch 7, make the selective connection between the network voltage V_{AC} and the main winding R at the knot that makes the connection of the main winding R with the start winding S (see knot C). In both embodiments, the methodology and implementation are equal.

Further, according to the teachings of the present invention, one provides an electric motor 6 comprising the control system that implements these steps of the methodology foreseen herein.

As far as the method of actuating a single-phase motor 6 of the present invention is concerned, it is applied to single-phase induction motors 6 in general, such motors having a basic configuration already described. In terms of operation, the following steps should be followed.

(A) Connecting the start winding S in parallel with the main winding R, keeping both of them disconnected from the network voltage V_{AC} and keeping them in this way for a first start time tₐ, so that the complete engagement of the contacts of the start switch 2 is guaranteed;
(B) After the first start time tₐ has passed, simultaneously keeping the start winding S and the main winding R connected to the network voltage V_{AC} for a second start time t_{b}, the second start time t_{b} being configured to be sufficiently long, so that the motor 6 can reach the speed suitable for disconnection of the auxiliary winding to keep it running adequately after said disconnection in other words, to keep it running after start; and
(C) After the second start time t_{b} has passed, disconnecting the start winding S from the network voltage V_{AC} and when the motor 6 is turned off, in the event of a new start, the methodology foresees that the motor should be restarted by the step A.

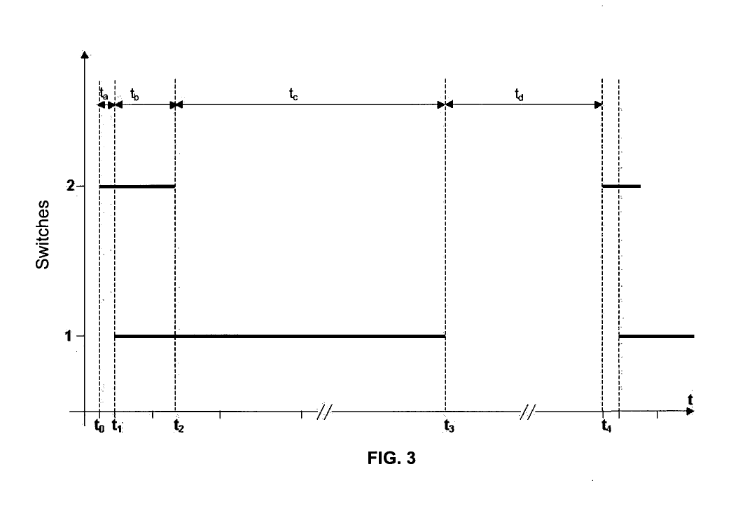

In operational terms, the above steps are translated into the graph illustrated in FIG. 3, where the first and second start times tₐ and t_{b} are shown as follows:

first start time tₐ passes between the time t_{b} and a time t₁, while the second start time t_{b} passes between the time t₁ and a time t₂.

In this way, initially at the moment tₐ the start switch 2 is commanded to close the circuit of which the start capacitor 5 and the discharge resistor 3 are part. Moments later, in t₁, the run switch 1, 7 is actuated, energizing the main winding R and the auxiliary winding S through the run capacitor 4 and the start branch. As already described, this sequence of actuation guarantees that, once the motor 6 has been energized, the run capacitor 4 will be discharged, preventing a discharge thereof through the circuit formed by the run capacitor 4, start capacitor 5, if any, and the start switch 2.

Once the motor 6 has accelerated so as to reach the velocity sufficient to guarantee a successful start, which takes place at the moment t₂, the start switch 2 is turned off and the start of the motor 6 is completed. With regard to the duration of the time t₂, there are several ways of detecting whether the motor 6 has reached the sufficient and optimum velocity for disconnection of the start winding S, measuring both the voltage and the total current or voltage in the auxiliary winding, for instance, as proposed in the patent document WO2005/034330, or still by employing a centrifugal switch.

The motor 6 continues running (see time line t_{c}) until at the moment t3 the control receives the information and/or determines that this is the moment of effecting the stoppage thereof. At this moment the run switch 1, 7 is commanded to open the circuit.

Further as a part of the operation strategy, the control method can guarantee that the motor 6 will remain for a determined time in the stoppage condition (for a stoppage time t_{d}—see line of time t_{d}), until the actuation strategy is repeated from the moment t4, when the routine is repeated from the time t₀ for a first start time tₐ. That time may vary from case to case and enables, in some situations, the motor 6 will to be in an advantageous condition for the next start. For instance, in the case of using the present invention on a compressor, one can project the duration of time t_{d} for a period necessary for the pressures to equalize and a new start will require less effort of the motor 6, avoiding the use of the start capacitor 5.

In these conditions, an additional step (D) is foreseen, wherein the control unit keeps the run switch 1 or 7 inactive and open and the start switch 2 for the stoppage time t_{d}, the stoppage time t_{d} being sufficiently long for the pressures of a compressor to equalize.

Moreover, the objective of providing a more robust system and method is strongly achieved in the case of the application of single-phase induction motors on compressors used in cooling. In this regard, following the teachings of the present invention, one achieves greater robustness than that achieved in a prior-art system, by avoiding situations that would normally the load to stress, as for instance the repetitive actuation of the thermal protector employed in these cases, in a condition of overheating and failure of start due to undervoltage of the feed network that supplies network voltage V_{AC}. At the same time, it is more flexible, since it can be employed in the four types of motors that use auxiliary winding for start.

With the system and method of the present invention, it is possible to achieve the objectives of providing a method of actuating a single-phase motor capable of meeting, with a single device, motors of CSR, CSIR, RSIR and RSCR types and still enables one not to employ the start capacitor 5. An example in this regard is when the method and system are applied to cooling systems that use capillary tube as an expansion device, which translates into an economical advantage to the system that uses this control method, thus reducing the total cost.

Preferred embodiments having been described, one should understand that the scope of the present invention embraces other possible variations, being limited only by the contents of the accompanying claims, which include the possible equivalents.

1. A method of actuating single-phase motor (6), the motor (6) being fed by a network voltage (V_{AC}) and comprising a main winding (R) and a start winding (S), connectable to the network voltage (V_{AC}) by means of a run switch (1,7), the motor (6) further comprising a start circuit (P) selectively connectable in series with the start winding (S) by means of a start switch (2), the start switch (2) comprising contacts,
the method being characterized in that, for the start of the motor (6), it comprises the step of:
(A) connecting the start winding (S) in parallel with the main winding (R) keeping both disconnected from the network voltage (V_{AC}) and keeping them in this way by means of a start time (tₐ);
(B) after the first start time (tₐ), simultaneously keeping the start winding (S) and the main winding (R) connected to the network voltage (V_{AC}) for a second start time (t_{b}); and
(C) after the second start time (t_{b}) has passed, disconnecting the start winding (S) from the network voltage (V_{AC}).

2. A method of actuating single-phase motor (6) according to claim 1, characterized in that in step A the first start time (tₐ) is configured for the contacts of the start switch (2) to be engaged.

3. A method of actuating single-phase motor (6) according to claim 1, characterized in that, after the step C, when the motor (6) is disconnected, for a new start, it is reinitiated by the step A.

4. A method of actuating single-phase motor (6) according to claim 1, characterized in that the second start time (t_{b}) is configured so as to be sufficiently long, in order to guarantee the start of the motor (6).

5. A method of actuating single-phase motor (6) according to claim 4, characterized in that, after the step C, a step D is foreseen to keep the run switches (1, 7) and the start switch (2) open.

6. A method of actuating single-phase motor (6) according to claim 5, characterized in that the step D comprises a stoppage time (t_{d}), the stoppage time (t_{d}) being sufficiently long so that, when the motor (6) is used for moving the compressor applied in a cooling system using a capillary tube as an expansion device, the suction and discharge pressures of the cooling system become equalized.

7. A system for actuating a single-phase motor (6), the motor (6) being feedable by a network voltage (V_{AC}) and comprising a main winding (R) and a start winding (S), the motor (6) further comprising a start circuit (P) selectively connectable in series with the start winding (S), and a run capacitor (4), the run capacitor (4) being connected in parallel to the start circuit (P),
the system being characterized by comprising a control unit configured so that, whenever the motor (6) is on, connecting the start winding (S) in parallel with the main winding (R), keeping both disconnected from the network voltage (V_{AC}) and keeping them in this way for a first start time (tₐ), then simultaneously keeping the start winding (S) and the main winding (R) connected to the network voltage (V_{AC}) for a second start time (t_{b}) and disconnecting the start winding (S) from the network voltage (V_{AC}).

8. A system according to claim 7, characterized in that the start circuit (P) includes a start capacitor (5) and a run capacitor (4), the start capacitor (5) being selectively connectable in series with the start winding (S) and the run capacitor (4) being connected in parallel with the start circuit (P).

9. A system according to claim 8, characterized in that the control unit is configured so that the first start time (tₐ) will have the duration necessary for the contacts of the start switch (2) to be engaged.

10. A system according to claim 9, characterized in that the control unit is configured so that the second start time (t_{b}) will be sufficiently long to guarantee the start of the motor (6).

11. A system according to claim 10, characterized by comprising a run switch (1, 7), the run switch (1, 7) being bidirectional in current and voltage and having a terminal connected to the network voltage (V_{AC}) and the other terminal connected to the main winding (R) of the motor (6).

12. A system according to claim 11, characterized by comprising a start switch (2), the start switch being bidirectional in current and voltage and having a terminal connected to the main winding (R) of the motor (6).

13. A system according to claim 12, characterized in that the other terminal of the start switch (2) is connected to the start winding (S).

14. A system according to claim 13, characterized in that the other terminal of the start switch (2) is connected to the start capacitor (5) when the latter is present.

15. A system according to claim 14, characterized in that the run capacitor (4) is connected in parallel with the start winding (S) and the run winding (R).

16. A system according to claim 15, characterized in that the start circuit (P) comprises a discharge resistor (3) connected in parallel with the start capacitor (5).

17. An electric motor characterized by comprising a control system as defined in claims 7 to 16.
